(19) United States
(12) Patent Application Publication
(10) Pub. No.: US 2011/0208336 A1
(43) Pub. Date: Aug. 25, 2011

(54) SYSTEM AND METHOD FOR PLAYING MEDIA FILES STORED ON A PORTABLE MEDIA PLAYER USING A CONNECTED DEVICE

(75) Inventors: Steven L. Cooper, Whitestown, IN (US); James Duane Tenbarge, Fishers, IN (US)

(73) Assignee: SHENZHEN TCL NEW TECHNOLOGY LTD., Shekou, Shenzhen, Guangdong (CN)

(21) Appl. No.: 13/125,964

(22) PCT Filed: Feb. 19, 2009
(86) PCT No.: PCT/US09/34536

§ 371 Date: Apr. 25, 2011

(30) Foreign Application Priority Data
Nov. 17, 2008 (CN) 200810177608.6

(51) Int. Cl. G06F 17/00

(52) U.S. Cl. 700/94

(57) ABSTRACT

An exemplary electronic device comprises a media subsystem that may comprise and audio subsystem, a display subsystem, or both. The media subsystem is adapted to play media files, including still pictures, audio files, or video files, or any combination thereof. The exemplary electronic device additionally comprises an interface that is adapted to place the electronic device in communication with a portable media player. The electronic device may store directory information for the portable media player. This directory information may be used to transfer media files from the portable media player to the electronic device for play on the media subsystem.

### BACKGROUND

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Many portable media devices are intended to store and play media files, such as audio files, video files, digital still picture files, and the like. To facilitate the playing of media files, these devices often have audio circuitry, a video display, or both. However, the small size of the devices may make it difficult to play media files on an external speaker or so that the media files may be effectively played for larger groups. To facilitate playing media files for larger groups, a portable device may have outputs that allow analog audio signals and analog video signals to be sent from the portable device to a larger device, such as a stereo system or television. However, even when connected to these larger devices, all control for playing the media files, such as choosing the particular media files to be played, is performed using the controls located on the portable device. Further, the user is limited to the play-lists, i.e., the lists of media files intended for sequential playback, previously generated on the portable device.

### BRIEF DESCRIPTION OF THE DRAWINGS

In the drawings:

FIG. 1 is a block diagram of an electronic device in accordance with an exemplary embodiment of the present invention; and

FIG. 2 is a process flow diagram illustrating a method in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An exemplary embodiment of the present invention relates to an electronic device (for example, a television, a stereo system, and the like) that has an interface for connection to a portable media player. Portable media players comprise portable audio players, portable video players, portable mixed media players, or any other player that lists the stored media files in a directory. The electronic device may have a media subsystem to facilitate the play of media files, such as an audio subsystem, a video display, or both. Further, the electronic device may have a user interface for entering commands that may be used to control the electronic device, the portable media player, or both.

When connected to the electronic device, the portable media player may transfer directory information to the electronic device, including play-lists. The directory information may be stored on the electronic device both for current use while connected to the portable media player and for future use when re-connected to the portable media player. When the portable media player is connected to the electronic device, the accuracy of any directory information previously-stored in the electronic device may be automatically checked by comparison to the directory information stored on the portable media player and the user may be prompted to allow the unit to correct any inaccurate entries. Optionally, the electronic device may correct any inaccuracies in the directory information automatically.

Further, the user may create local play-lists on the electronic device that are not stored on the portable media player. These play-lists are created using a user interface on the electronic device, and may be saved for future use. The electronic device may also be directly used to play media files from the portable media player.

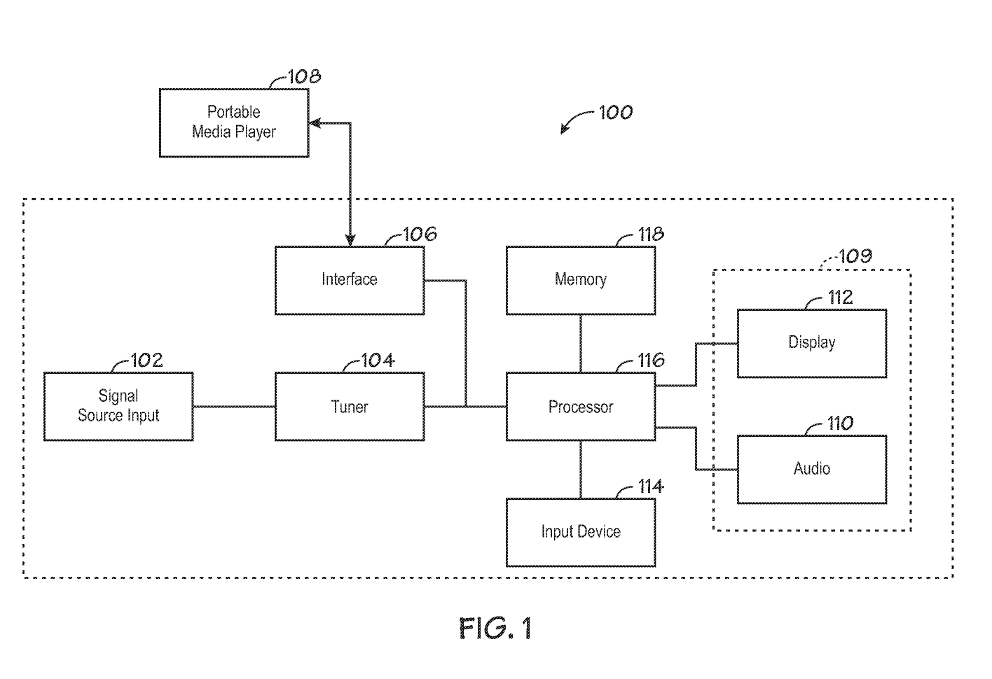

FIG. 1 is a block diagram of an electronic device in accordance with an exemplary embodiment of the present invention. The electronic device is generally referred to by the reference number 100. The electronic device 100 comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

The electronic device 100 may have a signal source input 102, which may comprise an antenna input, an RCA input, an S-video input, a composite video input or the like. Those of ordinary skill in the art will appreciate that, although only one signal source is shown, the electronic device 100 may have multiple signal source inputs. The signal source input 102 is adapted to receive a signal that comprises video signals and/or audio signals. The signal received by the signal source input 102 may comprise a broadcast spectrum (e.g., if the signal source input 102 comprises an antenna) or a single channel of video and/or audio signal (e.g., if the signal source input 102 is connected to the analog audio or video output of a portable media player).

A tuner subsystem 104 is adapted to tune a particular video program from a broadcast signal received from the signal input source 102. Those of ordinary skill in the art will appreciate that input signals that are not received as part of a broadcast spectrum may bypass the tuner 104 because tuning is not required to isolate a video program associated with those signals.

An interface 106 may comprise a wireless network connection, an Ethernet connection, a Universal Serial Bus (USB) connection or any other suitable connection that allows the electronic device 100 to communicate with an external unit, such as a portable media player 108. As discussed below, the interface 106 may be used for the transfer of command and control information between the electronic device 100 and the portable media player 108, comprising commands from the electronic device 100 to the portable media player 108, directory information from the portable media player 108 to the electronic device 100, and the like. Further, the interface 106 may be used to send media files from the portable media player 108 for play by the electronic device 100. These media files may comprise digital still pictures, audio files, or video files, or any combination thereof.

The electronic device 100 may comprise a media subsystem 109, comprising an audio subsystem 110, a display subsystem 112, or both. The audio subsystem 110 may comprise an audio amplifier and one or more speakers connected to the audio amplifier and may be adapted to play audio files, including audio files associated with video files being displayed by the electronic device 100. The display subsystem 112 may comprise a liquid crystal (LCD) display, a liquid-crystal-on-silicon (LCOS) display, a digital light projection (DLP) display or any other suitable display type. The display subsystem 112 may also comprise a lighting source (not shown) that is used to generate a visible image on the display.

The portable media player 108 includes a self-contained and portable electronic device configured to store and play digital media.

Moreover, the portable media player 108 includes a device that is easily transported by a user and capable of independent use in a variety of environments, such as while traveling in a plane or while working out. For example, the portable media player 108 may include an audio, video, or multi-media player such as an iPod® commercially available from Apple, Inc., a Zune commercially available from Microsoft, a LYRA™ commercially available from RCA, or the like.

An input device 114 may be used to enter user data into the electronic device 100. In an exemplary embodiment of the present invention, the input device 114 may comprise a remote control, buttons on the front panel of the electronic device 100, a keypad on the front of the electronic device 100, or the like. The input device 114 and the media subsystem 109 together may comprise a user interface for the entry of commands for the control of the electronic device 100, the portable media player 108, or both. For example, the user interface may be used to instruct the electronic device 100 to play specific media files stored on the portable media player 108. Further, the user may build play-lists for the portable media player 108 that are stored on the electronic device 100, or instruct the electronic device 100 to play any portion of the content stored on the portable media player 108 in a random or sequential fashion.

A processor 116 is adapted to control the overall operation of the electronic device 100, including the decoding of digital audio or video files transferred from the portable media player 108. A memory 118, which may comprise a read only memory (ROM), may be associated with the processor 116 to hold machine-readable computer code that causes the processor 116 to control the operation of the electronic device 100. The memory 118 may also comprise a random access memory (RAM) to be used for storage of directory information for the portable media player 108, including, for example, file lists, play-lists, and the like. To prevent the loss of such data during power failures, the RAM portion of memory 118 may comprise a non-volatile memory, such as an electrically erasable programmable read only memory (EEPROM), a flash memory, or any other suitable non-volatile memory, including a hard disk drive, a micro-disk drive, and the like.

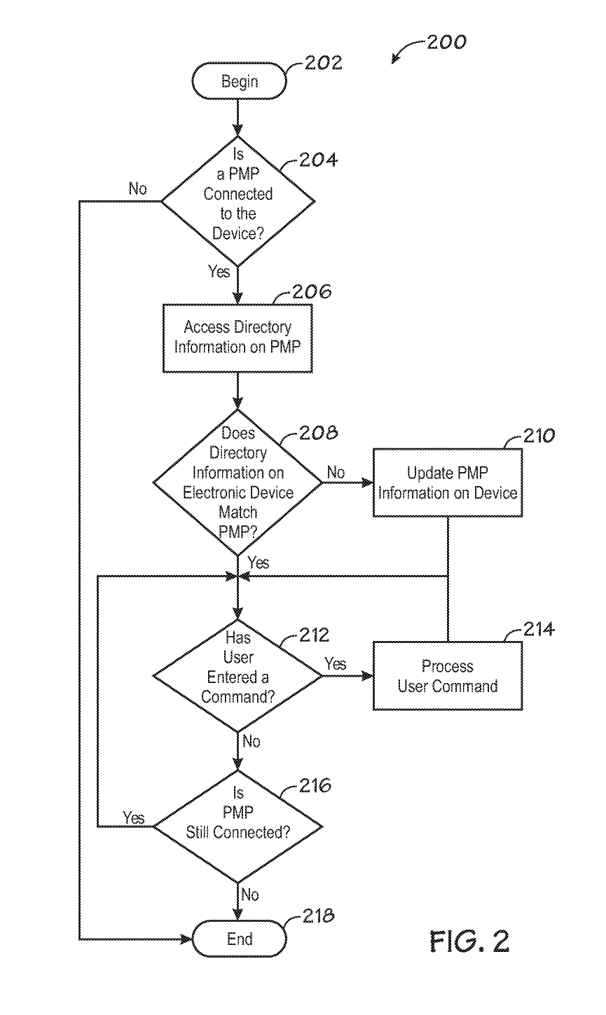

As set forth above, an electronic device 100 in accordance with an exemplary embodiment is adapted to allow a user to access content stored on the portable media player 108 and to play that content using appropriate subsystems of the electronic device 100. The details of how content from the portable media player 108 is accessed and played by the electronic device 100 are explained below with reference to FIG. 2.

FIG. 2 is a process flow diagram illustrating a method in accordance with an exemplary embodiment of the present invention. The process is generally referred to by the reference number 200. At block 202, the process begins.

At block 204, a determination is made about whether the electronic device 100 (FIG. 1) is connected to a portable media player 108 (FIG. 1). The connection may comprise a cable physically connecting the interface 106 to the portable media player 108. Alternatively, the connection may be made using digital radio signals. For example, a connection may be automatically established if a portable media device 108 comprising a radio interface, (e.g., a wireless network transceiver, a Bluetooth transceiver, or the like) is placed in range of an electronic device 100 having an interface 106 comprising a similar transceiver. If no connection has been established between the electronic device 100 and a portable media player 108, the process ends at block 218.

If a portable media player 108 is connected to the electronic device 100, at block 206 the electronic device 100 may access the directory information on the portable media player 108. At block 208, the directory information for the portable media player 108 that is stored on the electronic device 100 (if any) is compared to that stored on the portable media player 108. If the directory information for the portable media player 108 that is stored on the electronic device 100 does not match that stored on the portable media player 108 (or no information has been previously-stored), the directory information stored on the electronic device 100 is updated at block 210. This update may be performed automatically by the electronic device 100. Alternatively, the electronic device 100 may prompt the user to either allow automatic correction of the directory information or to manually correct the directory information using the user interface.

Once the directory information for the portable media player 108 that is stored on the electronic device 100 is correct, at block 212 the electronic device 100 determines if a command has been entered by the user. If a command has been entered, the command is processed at block 214. User commands may comprise such commands as the entry of new play-lists on the electronic device 100 or the initiation of play, on the electronic device 100, of media files contained in a play-list transferred from the portable media player 108.

Other commands may comprise the initiation of play on the electronic device 100, of a single media file or groups of media files from the portable media player 108, and the like. The media files may be completely transferred from the portable media player 108 and stored in the memory 118 of the electronic device 100, before being played on the media subsystem 109 from the memory 118. Alternatively, the media files may be accessed from the electronic device 100 and continuously transferred, or streamed, from the portable media player 108 during play by the electronic device 100. The portable media player 108 may play such streaming files through the signal source input 102 of the electronic device 100, or may stream the media files through the interface 106. Once the processing of the user command is completed, the process returns to block 212 for the electronic device 100 to determine if another command has been entered by the user.

If no command has been entered by the user, at block 216 the electronic device 100 determines if the portable media player 108 is still connected. If the portable media player 108 is still connected, the process returns to block 212 and the electronic device 100 determines if a command has been entered by the user. If the electronic device 100 determines that the portable media player 108 is no longer connected, the process ends at block 218.

The following example is intended merely to illustrate the operation of an exemplary embodiment of the present invention. The portable media player 108 may contain numerous media files comprising both audio and video files by various artists, as well as digital still pictures. In this example, the portable media player contains ten audio files by artist ‘A,’ and five audio files by artist ‘B,’ among others. Further, the exemplary portable media player 108 contains two video files by artist ‘B,’ as well as several digital pictures. The portable media player 108 also contains a first play-list that sequentially lists three of the audio files by artist ‘A’ and two of the audio files by artist ‘B,’ and a second play-list that includes both of the video files by artist ‘B.’ In this exemplary embodiment, the electronic device 100 is a television adapted to function as described with respect to FIGS. 1 and 2, above.

Upon initial connection to the portable media player 108, the television sends a command to the portable media player 108 to download all directory information, comprising a complete list of all media files present on the portable media player 108 as well as both play-lists. If the television has been previously connected to this particular portable media player 108, the television compares any previously saved directory to the current directory downloaded from the portable media player 108 and makes any needed corrections to ensure an accurate directory is stored in the television.

Once the directory update is completed, the television may then display a user interface screen, comprising, for example, the list of files and play-lists for the portable media player 108, which is stored on the television. The user may then input a command through the user interface of the television. For example, the user may instruct the television to play the media files contained in the first play-list downloaded from the portable media player 108 by highlighting and selecting the name of the play-list. Accordingly, the television would sequentially instruct the portable media player to send the first audio file in the play-list and play the file through the audio subsystem 110. Upon completion of the play of the first audio file, the television would then instruct the portable media player 108 to send the next audio file in the play-list, and so on, until all of the audio files in the first play-list have been played. Upon completion of play of all media files in the play-list, the television would return to displaying a user interface screen, and await the next command.

Alternatively, the user may use the user interface to create a new play-list, stored only in the television. For example, this play-list may sequentially list three audio files by artist ‘B,’ and both of the video files by artist B′. Once the user selects this play-list, the television would sequentially play each audio file on the audio subsystem 110, instructing the portable media player 108 to send the next audio file upon completion of play of the previous audio file. After completion of play of the audio files, the television would then instruct the portable media player 108 to send the first video file, which would be played by the television using both the audio subsystem 110 and the video subsystem 112. Upon completion of the first video file, the television would then instruct the portable media player 108 to send the next video file, which would then be played. Upon completion of play of all media files in the play-list, the television would return to displaying a user interface screen, and await the next command.

The television may be used to play individual media files or groups of media files from the portable media player 108 without the use of play-lists. For example, the user could instruct the television to sequentially play all of the files on the portable media player 108. Each file would then be played, with the television instructing the portable media player 108 to send the next file as the play of the previous file is competed. During this process, or during any other sequential operation, including the playing of media files contained in play-lists, the user may instruct the television to stop, and return to a command mode. Subsets of the media files on the portable media player 108 may also be played. For example, the user could instruct the television to play all audio files on the portable media player 108, either sequentially or randomly.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An electronic device, comprising:
a media subsystem adapted to play a media file, wherein the media subsystem comprises an audio subsystem, or a display subsystem, or a combination thereof;
an interface that is adapted to connect the electronic device to a portable media player for the transfer of directory information from the portable media player to the electronic device; and
a user interface that allows a user to select at least one media file using the directory information to enter a command to access the at least one media file on the portable media player, and to play the at least one media file on the media subsystem.

2. The electronic device of claim 1, wherein the user interface allows a user to enter a command to transfer the directory information from the portable media player to the electronic device.

3. The electronic device of claim 1, wherein the electronic device automatically transfers the directory information from the portable media player when the portable media player is connected to the interface.

4. The electronic device of claim 1, wherein the media file comprises a digital picture, an audio file, or a video file, or any combination thereof.

5. The electronic device of claim 1, wherein the directory information comprises file names, file types, or play-lists, or any combination thereof.

6. The electronic device of claim 1, wherein the interface allows the transfer of commands from the electronic device to the portable media player.

7. The electronic device of claim 1, wherein a media file is continuously streamed from the portable media player to the electronic device during play, or is transferred from the portable media device to a memory on the electronic device before play, or any combination thereof.

8. The electronic device of claim 1, wherein the electronic device contains a previously-stored copy of the directory information for the portable media device.

9. The electronic device of claim 8, wherein the electronic device is configured to compare the previously-stored copy of the directory information for the portable media device with the directory information transferred from the portable media player and configured to correct any differences in the previously-stored copy.

10. The electronic device of claim 1, wherein the user interface allows the user to build a play-list stored on the electronic device containing a list of media files on the portable media player.

11. A method of playing at least one media file stored on a portable media player using a media subsystem of an electronic device to which the portable media player is connected, the method comprising:
transferring directory information from the portable media player to the electronic device; and
displaying a user interface that allows a user to select the at least one media file using the directory information to enter a command to access the at least one media file on the portable media player, and to play the at least one media file on the media subsystem.

12. The method of claim 11, wherein the directory information comprises file names, file types, or play-lists, or any combination thereof.

13. The method of claim 11, wherein the at least one media file comprises a picture, an audio file, or a video file, or any combination thereof.

14. The method of claim 11, comprising:
transferring the at least one media file from the portable media player to a memory on the electronic device; and
playing the at least one media file from the memory of the electronic device.

15. The method of claim 11, comprising:
making a play-list in the electronic device;
storing the play-list in a memory of the electronic device; and
playing the at least one media file listed in the play-list on the media subsystem of the electronic device under the control of the electronic device.

16. The method of claim 11, comprising:
comparing the directory information for the portable media player stored in the electronic device with the directory information stored in the portable media player; and
correcting any differences in the directory information stored in the electronic device.

17. The method of claim 11, comprising:
selecting a play-list transferred from the portable media player to the electronic device; and
playing the at least one media file listed in the play-list on the media subsystem of the electronic device under the control of the electronic device.

18. The method of claim 11, comprising:
instructing the electronic device to randomly select a media file on the portable media device; and
playing the randomly selected media file on the media subsystem of the electronic device under the control of the electronic device.

19. The method of claim 11, comprising:
instructing the electronic device to sequentially select a media file on the portable media device; and
playing the sequentially selected media file on the media subsystem of the electronic device under the control of the electronic device.

20. An electronic device that is adapted to play at least one media file stored on a portable media player to which the electronic device is connected, the electronic device comprising:
means for transferring directory information from the portable media player to the electronic device; and
means for displaying a user interface that allows a user to select the at least one media file using the directory information to enter a command to access the at least one media file on the portable media player, and to play the at least one media file on a media subsystem of the electronic device.
